(19) United States
(12) Patent Application Publication
(10) Pub. No.: US 2006/0257573 A1
(43) Pub. Date: Nov. 16, 2006

(54) Drywall mastic application device

(76) Inventor: Timothy Smythe, Bend, OR (US)

Correspondence Address: Clifford Kraft, 320 Robin Hill Dr., Naperville, IL, 60540, US

(21) Appl. No.: 11/412,421

(22) Filed: Apr. 27, 2006

Related U.S. Application Data
(60) Provisional application No. 60/676,683, filed on Apr. 29, 2005.

(51) Int. Cl. B28B 3/00; B05C 1/00

(52) U.S. Cl. 427/355; 425/87; 118/200

(57) ABSTRACT

A drywall mastic applicator or nail spotter that includes a mastic box with an open end and a plunger the fits into the open end that effectively seals it. The box can have a hole or other opening in another surface opposite the plunger so that when the plunger is depressed, the mastic exits the hole. A blade containing at least one groove can be mounted near the hole so that the mastic is applied as an exact bead. The blade can contain several grooves to produce a sting of beads. This arrangement speeds up taping and finishing drywall by applying an exact amount of mastic in the right place in the form of a bead.

This application is related to, and claims priority from, U.S. Provisional application No. 60/676,683 filed Apr. 29, 2005. Application No. 60/676,683 is hereby incorporated by reference.

### BACKGROUND

1. Field of the Invention

The present invention relates generally to the field of drywall installation and more particularly to a nail spotter for drywall taping mastic application.

2. Description of the Prior Art

Nail spotters are generally a common tool in the drywall installation art. They are used to apply mastic over depressions or dimples that remain after screwing or nailing up a drywall board. Nail spotters can also be used to put a feathering coat of mastic over a taped joint after the initial installation of the tape to the joint.

Prior art nail spotters are usually a sheet metal box which is filled with mastic (drywall mud). On side of the box is normally open. After the box is filled with mastic, a plunger is fitted into the open side of the box. The plunger is designed to seal around the inside surface of the box. The plunger effectively closes the box with the mastic inside. There is usually a small opening in the bottom of the box opposite the plunger through which mastic can pass from the box out onto the surface of the sheet rock board. On one side of the opening, there is normally a blade which can slide across the surface of the drywall board to wipe off the excess mastic and hence create a smooth surface of applied mastic that is flush with the drywall board.

What is badly needed is a nail spotter where the blade has grooves to apply the mastic in beads with an accurately controlled amount of mastic being dispensed. This type of mastic application eliminates the need for finishing and speeds up the process of taping or joint finishing by providing exactly the right amount of mastic in the right place.

### SUMMARY OF THE INVENTION

The present invention relates to a drywall mastic applicator that includes a mastic box with one end open, a plunger inserted into the open end of the box after the box is filled with mastic, a hole in the box opposite from the open end, and a blade coupled to an exterior surface of the box, the blade being in proximity to the hole with the blade containing one or more grooves. The grooves allow the mastic to be dispensed as beads in an exact quantity in exact placement. The box can be plastic or any other material, and the blade can be metal or plastic. The blade can have any number of grooves with 3-4 grooves being preferred. The blade can also have only one groove if desired. Interchangeable blades can contain different numbers of grooves.

### DESCRIPTION OF THE FIGURES

The following figures are presented to aid in the understanding of the present invention.

FIG. 1 shows a perspective view of an embodiment of the present invention.

FIG. 2 shows the embodiment of FIG. 1 being used to apply mastic to a drywall seam.

Several drawings and illustrations have been presented to better aid in the understanding of the present invention. The scope of the present invention is not limited to what is shown in the figures.

### DESCRIPTION OF THE INVENTION

The present invention relates to the application of mastic and more particularly to a nail spotter (mastic applicator) for the drywall trades that is able to lay down one or more beads of mastic in exactly the right place with exactly the right quantity for subsequent taping or finishing.

The present invention generally modifies the prior art flat blade by adding grooves so that the device can be used to apply a first coat of mastic in the form of a bead or group of beads with accurately controlled quantity and location of the mastic on the drywall. This makes the initial application of the mastic to the joints between adjacent drywall boards very fast and efficient due to the quick application and exact placement of the precise amount of mastic needed on each side of the joint. This saves the installer much time in applying joint finishing or taping products to a wall or ceiling.

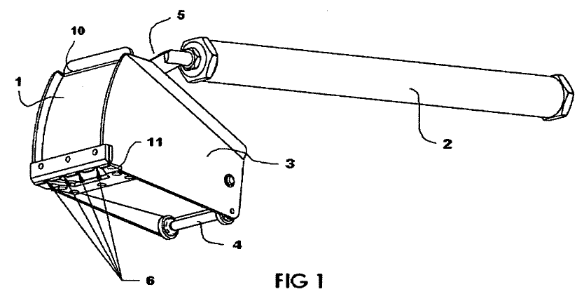

Turning to FIG. 1, a perspective view of an embodiment of the present invention can be seen. A box 3 is attached to a handle 2 through a joint 5. The joint 5 allows the box 3 to be placed flat on a drywall joint the box has a blade 1 that has one or more grooves 6 in its leading edge. A roller 4 can be used to make the box motion easier and more uniform. As mastic or mud is plunged out of the box 3 by applying pressure on the handle 3 which depresses a plunger 10. Mastic exits a hole 11, and the grooves 6 in the blade cause beads of exact size and mastic quantity to be formed. The beads trail out as the box is moved along the seam on the roller 4 and the blade 1.

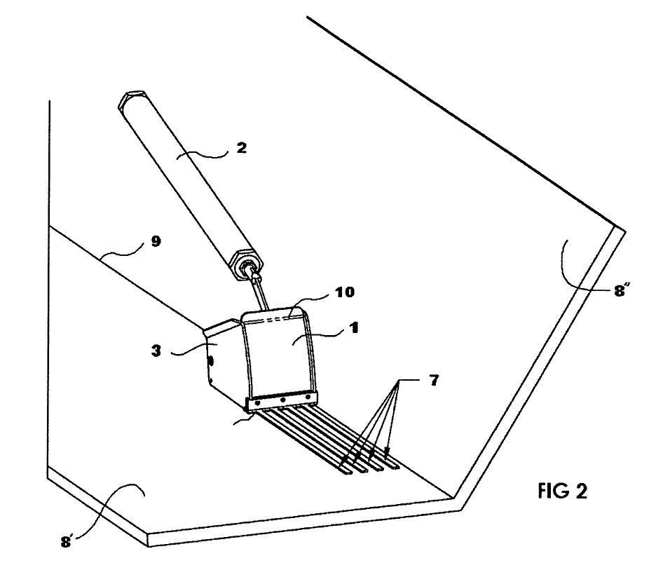

FIG. 2 shows the functioning of the embodiment of the present invention from FIG. 1. The box 3 is caused to run along one edge of a drywall seam 9 formed by two pieces of drywall 8′, 8″. As pressure is put on the handle, the blade 1 allows mastic to escape through the groove or grooves 6 forming perfect beads 7 of mastic. The process can be repeated on the opposite side of the seam to complete the mastic application. Taping or finishing can then be done.

To use the present invention, the finisher loads mastic into the box with the plunger removed. The plunger is replaced. The device is held by the handle and placed against the drywall seam with the grooves in the blade flat against the drywall. The operator pushes on the handle, which pushes on the plunger, forcing mastic out of the hole or small opening in the bottom of the box. The grooves in the blade cause the mastic to bead. Different blades can be supplied with different numbers of grooves for different types of jobs.

Several descriptions and illustrations have been presented to aid in the understanding of the present invention. One of skill in the art will realize that there are numerous variations and changes that can be made without departing from the spirit of the invention. Each of these changes and variations is within the scope of the present invention.

I claim:

1. A drywall mastic applicator comprising:
a mastic box with one end open;
a plunger inserted into the open end of said box after said box is filled with mastic;
a hole in said box opposite said open end;
a blade coupled to an exterior surface of said mastic box, said blade in proximity to said hole, said blade containing at least one groove.

2. The drywall mastic applicator of claim 1 wherein said blade contains a plurality of grooves.

3. The drywall mastic applicator of claim 1 further comprising a plurality of interchangeable blades each with a different number of grooves.

4. The drywall mastic applicator of claim 1 wherein said box is plastic.

5. The drywall mastic applicator of claim 1 wherein said blade is metal.

6. The drywall mastic applicator of claim 1 wherein said blade is plastic.

7. The drywall mastic applicator of claim 1 wherein said blade contains exactly one groove.

8. The drywall mastic applicator of claim 1 wherein said blade contains four grooves.

9. A drywall mastic applicator device of the type with a plunger box and a blade for applying mastic to a drywall seam by pressing on a plunger with a handle as the plunger box is moved along a drywall seam, the improvement comprising at least one groove in said blade.

10. The drywall mastic applicator device of claim 9 wherein said blade contains a plurality of grooves.

11. The drywall mastic applicator device of claim 9 wherein said blade contains exactly one groove.

12. The drywall mastic applicator device of claim 9 wherein said box is plastic.

13. The drywall mastic applicator device of claim 9 wherein said blade is metal.

14. The drywall mastic applicator device of claim 9 wherein said blade is plastic.

15. A method for applying drywall mastic to a drywall seam comprising the steps of:
loading mastic into a mastic applicator device, said device having a box with an open face and a hole in a face opposite said open face;
placing a plunger into the open end of said box;
placing a blade over said hole, said blade having at least one groove;
running said mastic applicator device along said drywall seam while pressing on said plunger, wherein
said mastic is pressed out of said hole and through said groove to form a bead.

16. The method of claim 16 wherein said box is plastic.

17. The method of claim 16 wherein said blade has a plurality of grooves.

18. The method of claim 16 wherein said blade has exactly one groove.

19. The method of claim 16 wherein said blade is metal.

20. The method of claim 16 wherein said blade is plastic.
